(19) United States
(12) Patent Application Publication
(10) Pub. No.: US 2025/0175819 A1
(43) Pub. Date: May 29, 2025

(54) ANALYSIS METHOD FOR EVALUATING AND OPTIMIZING WIRELESS ENERGY TRANSFER EFFICIENCY AND GAIN OF ELECTROMAGNETIC METASURFACES

(71) Applicant: XIDIAN University, Xi’an City (CN)

(72) Inventors: Long LI, Xi’an (CN); Zizhong CHEN, Xi’an (CN); Hao XUE, Xi’an (CN); Xiaonan WU, Xi’an (CN); Haixia LIU, Xi’an (CN); Xin WANG, Xi’an (CN)

(21) Appl. No.: 18/901,160

(22) Filed: Sep. 30, 2024

(30) Foreign Application Priority Data
Nov. 27, 2023 (CN) 202311593167.9

(51) Int. Cl. H04W 24/02; H01Q 15/00

(52) U.S. Cl. CPC H04W 24/02; H01Q 15/0086

(57) ABSTRACT

An analysis method for evaluating and optimizing wireless energy transfer efficiency and gain of electromagnetic metasurfaces comprises: acquiring total channel characteristics of an m^{th} metasurface unit in a system; acquiring a total channel characteristic matrix C of the metasurface in the system; acquiring a matrix U; acquiring a matrix T; acquiring a quadratic 0-1 integer programming problem for determining the energy transfer efficiency or gain; and using a solution of the above programming problem to obtain optimized energy transfer efficiency or optimized gain, and obtain optimized metasurface unit arrangement. Based on the Friis transmission equation and principle of electric field superposition, this method treats each metasurface unit as an independent radiator, and calculates the superposition of electromagnetic waves influenced by each unit at a receiver or in the far-field of the metasurface, therefore effectively improve the performance of wireless energy transfer, wireless communication, and simultaneous wireless information and power transfer.

### BACKGROUND OF THE PRESENT INVENTION

The invention belongs to the technical field of metasurfaces, and particularly relates to an analysis method for evaluating and optimizing wireless energy transfer efficiency and gain of electromagnetic metasurfaces.

### DESCRIPTION OF RELATED ARTS

In wireless energy transfer, wireless communication, and simultaneous wireless information and power transfer systems based on electromagnetic metasurfaces, the metasurface, as a transmitting terminal, needs to transmit energy and information to intended devices. In 2022, CHANG et al., proposed an application scenario of a reconfigurable metasurface-based simultaneous wireless information and power transfer system. This system utilizes a combination of focusing beams and directional beams for energy transfer based on the location of a sensor network. Focusing beams can converge electromagnetic waves at a specific point in space and are generally used in near-field applications, while directional beams can increase the propagation distance and achieve a higher gain in a specific direction, typically used in far-field applications. Existing design formulas for metasurface focusing and directional beams have simple calculation forms but overlook the changes in electromagnetic wave amplitudes due to spatial decay and unit characteristics.

### SUMMARY OF THE PRESENT INVENTION

To overcome the shortcomings of the prior art, the objective of the invention is to provide an analysis method for evaluating and optimizing wireless energy transfer efficiency and gain of electromagnetic metasurfaces. Based on the Friis transmission equation and the principle of electric field superposition, this method treats each metasurface unit as an independent radiator, and calculates the superposition of electromagnetic waves influenced by each unit at a receiver or in the far-field of the metasurface. This can effectively improve the performance of wireless energy transfer, wireless communication, and simultaneous wireless information and power transfer systems based on metasurfaces.

To achieve the above objective, the invention adopts the following technical scheme.

The analysis method for evaluating and optimizing wireless energy transfer efficiency and gain of electromagnetic metasurfaces comprises the following steps:
acquiring total channel characteristics Cₘ of an m^{th} metasurface unit in a system, m=1, 2, . . . , M, M being the total number of metasurface units;
acquiring a total channel characteristic matrix C of the metasurface in the system;
acquiring a matrix U, elements in U representing the influence of each state of the metasurface units on the amplitude and phase of electromagnetic waves;
acquiring a matrix T, elements in T representing the overall influence of each state of the metasurface units on the electromagnetic waves in the system;
acquiring a quadratic 0-1 integer programming problem for determining the energy transfer efficiency or gain; and
using a solution of the above programming problem to obtain optimized energy transfer efficiency or optimized gain, and obtain optimized metasurface unit arrangement.

The total channel characteristics Cₘ of an m^{th} metasurface unit in a system are acquired by the following steps:
establishing a rectangular coordinate system with a geometric center of the metasurface as the origin, and acquiring coordinate vectors RMₘ, RF and RH of the m^{th} unit, a feed and a receiver;
based on a pitch angle θ_{Fm} and an azimuth angle Φ_{Fm} of a relative coordinate vector RF-RMₘ between the feed and the m^{th} unit, acquiring actual gain G_{M}(θ_{Fm},Φ_{Fm}) of the m^{th} metasurface unit in a state of joint polarization with the feed in the direction of (θ_{Fm},Φ_{Fm}) and actual gain G_{F}(θ_{Fm},−Φ_{Fm}) of the feed in a state of joint polarization with the m^{th} metasurface unit in the direction of (θ_{Fm},−Φ_{Fm}), the gain being acquired by simulation;
based on a pitch angle θ_{Hm} and an azimuth angle Φ_{Hm} of a relative coordinate vector RH-RMₘ between the receiver and the m^{th} unit, acquiring actual gain G_{M}(θ_{Hm},Φ_{Hm}) of the m^{th} metasurface unit in a state of joint polarization with the receiver in the direction of (θ_{Hm},Φ_{Hm}) and actual gain G_{H}(θ_{Hm},−Φ_{Hm}) of the receiver in a state of joint polarization with the m^{th} metasurface unit in the direction of (θ_{Hm},−Φ_{Hm}), the gain being acquired by simulation;
based on the coordinate vectors and the gain, calculating channel attenuation aₘ from the feed to the m^{th} metasurface unit and channel attenuation bₘ from the receiver to the m^{th} metasurface unit according to the following formula:

$$\begin{matrix}{a}_{m} = \sqrt{{G}_{M} ( {θ}_{Fm} , {ϕ}_{F m} ) {G}_{F} ( {θ}_{Fm} , - {ϕ}_{F m} ) {( \frac{λ}{4 π \vert RF - R {M}_{m} \vert} )}^{2}} \\ {b}_{m} = \sqrt{{G}_{M} ( {θ}_{Hm} , {ϕ}_{H m} ) {G}_{H} ( {θ}_{Hm} , - {ϕ}_{H m} ) {( \frac{λ}{4 π \vert RH - R {M}_{m} \vert} )}^{2}}\end{matrix}$$

where λ denotes working wavelength;
calculating channel characteristics Fₘ from the m^{th} metasurface unit to the feed and the receiver and channel characteristics Hₘ to the receiver according to the following formula:

$$\begin{matrix}{F}_{m} = {a}_{m} exp ( - \frac{j 2 π \vert RF - {RM}_{m} \vert}{λ} ) \\ {H}_{m} = {b}_{m} exp ( \frac{j 2 π \vert RH - R {M}_{m} \vert}{λ} )\end{matrix}$$

calculating the total channel characteristic Cₘ of the m^{th} metasurface unit according to the following formula:

$${C}_{m} = {H}_{m}^{*} {F}_{m} .$$

In the above calculation process, the metasurface unit is regarded as an independent radiating unit. Because the aperture and far-field range of a single unit are small, the gain can be used to represent the channel attenuation of the two paths from the feed to the unit and from the unit to the receiver.

The total channel characteristic matrix C is acquired by the following steps:
grouping according to the total channel characteristics of each metasurface unit, that is, grouping together the units with the same total channel characteristics Cₘ among the M metasurface units;
acquiring the number dₙ of units contained in each group, n=1, 2, . . . , N, N being the number of groups; and
acquiring the total channel characteristic matrix C of the metasurface, elements in the matrix being the total channel characteristics Cₙ of each group of units, and the matrix size being N×1.

The matrix U is acquired by the following steps:
acquiring amplitude characteristics Sₗ and phase characteristics φₗ of the metasurface unit in the state l through simulation, l=1, 2, . . . , L, L being the number of states of the metasurface unit;
based on the amplitude characteristics and the phase characteristics, calculating the influence Uₗ of the metasurface unit on the amplitude and phase of the electromagnetic waves in the state l according to the following formula:

$${U}_{l} = \vert {S}_{l} \vert exp ( j {φ}_{l} )$$

acquiring the matrix U, elements in the matrix being the influence Uₗ of each state of the unit on the amplitude and phase of the electromagnetic waves, and the matrix size being 1×L.

When L is large, 4-bit sampling is performed on the amplitude and phase characteristics to acquire the matrix U for L=16.

The above-mentioned matrix U contains the amplitude characteristics and phase characteristics of the metasurface unit. By using this matrix for subsequent calculation, the problem that focusing and directional beams only consider the phase compensation of the unit and ignore the influence of amplitude in the system design is overcome.

The matrix T is acquired by the following steps:
based on the total channel characteristic matrix C and the matrix U, calculating the matrix T representing the overall influence of each state of each metasurface unit on the electromagnetic waves in the system according to the following formula:

$$T = C U$$

where the size of the matrix T is N×L.

The above matrix T contains all the possible influence of each unit on electromagnetic wave transmission in the metasurface design process. Through the above grouping and bit sampling, the size of the matrix T is reduced, and the data volume required for subsequent programming operation is reduced.

The quadratic 0-1 integer programming expression is acquired by the following steps:
based on the matrix T, mapping each complex element in the matrix into a plane vector \vec{a}ₙₗ;
based on the plane vector \vec{a}ₙₗ, acquiring the quadratic 0-1 integer programming expression of the energy transfer efficiency according to the following formula:

$$\begin{matrix}max & {{W}_{e} ( x ) = \vert {\sum }_{n = 1}^{N} {\sum }_{l = 1}^{L} {d}_{n} {\vec{a}}_{n l} {x}_{n l} \vert}^{2} \\ s . t . & \begin{matrix}{\sum }_{l = 1}^{L} {x}_{n l} = 1 & n = 1 , 2 , … , N\end{matrix} \\ & {x}_{n l} = 0 , 1\end{matrix}$$

where x denotes decision variable, xₙₗ being 1 means that the units in the n^{th} group are selected as state l, and xₙₗ being 0 means that the units in the n^{th} group are not selected as state l;
an objective function Wₑ(x) of the above expression being transformed into the following quadratic form:

$${W}_{e} ( x ) = {x}^{T} ( \begin{matrix}{d}_{1}^{2} {\vec{a}}_{1}^{2} & … & {d}_{1} {d}_{i} {\vec{a}}_{1} \cdot {\vec{a}}_{i} \\ ⋮ & ⋱ & ⋮ \\ {d}_{1} {d}_{i} {\vec{a}}_{1} \cdot {\vec{a}}_{i} & … & {d}_{i}^{2} {\vec{a}}_{i}^{2}\end{matrix} ) x$$

where i=1, 2, . . . , NL;
based on the Friis transmission equation, acquiring a quadratic 0-1 integer programming objective function W_{g} of the gain according to the steps and the following formula by placing the receiver outside a far-field boundary of the metasurface and setting the gain of the receiver to 1:

$${{W}_{g} ( x ) = {( \frac{4 π R}{λ} )}^{2} \vert {\sum }_{n = 1}^{N} {\sum }_{l = 1}^{L} {d}_{n} {\vec{a}}_{n l} {x}_{n l} \vert}^{2}$$

where R is the distance from a geometric center of the metasurface to a phase center of the receiver.

In the above calculation process, by performing vector superposition on radiation electric fields of each metasurface unit based on the principle of field superposition, the expressions of energy transfer efficiency and gain from the metasurface to the receiver are obtained.

Linearizing the quadratic 0-1 integer programming into the following form:

$$\begin{matrix}min & V ( x ) = {q}_{0} + {\sum }_{i = 1}^{N L} {q}_{ii} {x}_{i} + {\sum }_{\begin{matrix}i = 1 \\ i \neq k\end{matrix}}^{N L} {\sum }_{k = 1}^{N L} {q}_{i k} {p}_{ik} \\ s . t . & \begin{matrix}0 \leq {x}_{i} + {x}_{k} - 2 {p}_{ik} \leq 1 & i , k - 1 , 2 , … , NL & i < k\end{matrix} \\ & \begin{matrix}{x}_{i} = 0 , 1 & i = 1 , 2 , … , NL\end{matrix} \\ & \begin{matrix}{p}_{ik} = 0 , 1 & i , k = 1 , 2 , … , NL & i < k\end{matrix}\end{matrix}$$

acquiring a solution of the 0-1 integer linear programming problem through a solver;
using the solution of the above programming problem to obtain optimized energy transfer efficiency or optimized gain, and obtain optimized metasurface unit arrangement; and
for the above-mentioned 4-bit sampling, considering whether there are better results in other states of the metasurface unit before sampling.

A calculating device for evaluating and optimizing wireless energy transfer efficiency and gain of electromagnetic metasurfaces comprises a calculating module;
the calculating module is configured to perform the following operations:
acquiring total channel characteristics Cₘ of an m^{th} metasurface unit in a system, m=1, 2, . . . , M, M being the total number of metasurface units;
acquiring a total channel characteristic matrix C of the metasurface;
acquiring a matrix U, elements in U representing the influence of each state of the metasurface units on the amplitude and phase of electromagnetic waves;
acquiring a matrix T, elements in T representing the overall influence of each state of the metasurface units on the electromagnetic waves in the system;
acquiring a quadratic 0-1 integer programming problem for determining the energy transfer efficiency or gain; and
using a solution of the above programming problem to obtain optimized energy transfer efficiency or optimized gain, and obtain optimized metasurface unit arrangement.

The method is applied to the fields of wireless energy transfer, wireless communication, and simultaneous wireless information and power transfer.

The invention has the following beneficial effects.

The metasurface unit is regarded as an independent radiating unit. Because the aperture and far-field range of a single unit are small, the gain can be used to represent the channel attenuation of the two paths from the feed to the unit and from the unit to the receiver. The matrix U contains the amplitude characteristics and phase characteristics of the metasurface unit. By using this matrix for subsequent calculation, the problem that focusing and directional beams only consider the phase compensation of the unit and ignore the influence of amplitude in the system design is overcome. The matrix T contains all the possible influence of each unit on electromagnetic wave transmission in the metasurface design process. Through the above grouping and bit sampling, the size of the matrix T is reduced, and the data volume required for subsequent programming operation is reduced. By performing vector superposition on radiation electric fields of each metasurface unit based on the principle of field superposition, the expressions of energy transfer efficiency and gain from the metasurface to the receiver are obtained. By using numerical calculation and programming-based methods, compared to the pure simulation method, the invention has the advantages of high efficiency, fast operation, easy use, and small computational resource utilization.

### BRIEF DESCRIPTION OF THE DRAWINGS

FIG. 1 is a principle diagram of a method according to the invention;

FIG. 2 is a flowchart when the invention is implemented.

FIG. 3 is a structural diagram of a transmission unit of a four-layer windmill in an embodiment of the invention.

FIG. 4 is a schematic diagram of a far-field gain direction of a transmission unit of a four-layer windmill in an embodiment of the invention.

FIG. 5 is a structural diagram of a receiving antenna used in an embodiment of the invention.

FIG. 6 is a schematic diagram of far-field gain directions of a feed and a receiving antenna used in an embodiment of the invention.

FIG. 7 is a schematic diagram of a wireless energy transfer system based on a transmission metasurface in an embodiment of the invention.

FIG. 8 is a graph showing the variation of amplitude and phase characteristics of a transmission unit of a four-layer windmill with a unit structure in an embodiment of the invention.

FIG. 9(a) is a schematic diagram of matrix U plane mapping of a transmission unit of a four-layer windmill in an embodiment of the invention.

FIG. 9(b) is a schematic diagram of matrix U plane mapping after 4-bit sampling of a transmission unit of a four-layer windmill in an embodiment of the invention.

FIG. 10 is a schematic diagram of partial data plane mapping of a matrix T in an embodiment of the invention.

FIG. 11 is a graph showing the variation of focusing and optimizing energy transfer efficiency with R in an embodiment of the invention.

FIG. 12(a) is a schematic diagram of amplitude characteristic distribution of a metasurface optimized for energy transfer efficiency when R=0.52 m in an embodiment of the invention.

FIG. 12(b) is a schematic diagram of amplitude characteristic distribution of a focused metasurface for comparison of energy transfer efficiency when R=0.52 m in an embodiment of the invention.

FIG. 13(a) is a schematic diagram of phase characteristic distribution of a metasurface optimized for energy transfer efficiency when R=0.52 m in an embodiment of the invention.

FIG. 13(b) is a schematic diagram of phase characteristic distribution of a focused metasurface for comparison of energy transfer efficiency when R=0.52 m in an embodiment of the invention.

FIG. 14 is a schematic diagram of plane mapping of energy transfer contribution of each unit of a focused and optimized metasurface when R=0.52 m in an embodiment of the invention.

FIG. 15 is a simulation diagram of an electric field cross section at a distance of 520 mm for a focused and optimized metasurface in an embodiment of the invention.

FIG. 16 is a far-field gain direction diagram of a directional beam and optimized metasurface in an embodiment of the invention.

FIG. 17(a) is a schematic diagram of amplitude characteristic distribution of a metasurface optimized for gain in an embodiment of the invention.

FIG. 17(b) is a schematic diagram of amplitude characteristic distribution of a directional beam metasurface for gain comparison in an embodiment of the invention.

FIG. 18(a) is a schematic diagram of phase characteristic distribution of a metasurface optimized for gain in an embodiment of the invention.

FIG. 18(b) is a schematic diagram of phase characteristic distribution of a directional beam metasurface for gain comparison in an embodiment of the invention.

### DETAILED DESCRIPTION OF THE PREFERRED EMBODIMENT

The invention will be further described below with reference to the accompanying drawings.

The objective of the invention is to provide an analysis method for evaluating and optimizing wireless energy transfer efficiency and gain of electromagnetic metasurfaces, comprehensively considering the amplitude and phase characteristics of units, and improving the wireless energy transfer efficiency and gain performance of wireless energy transfer, wireless communication, and simultaneous wireless information and power transfer systems based on metasurfaces.

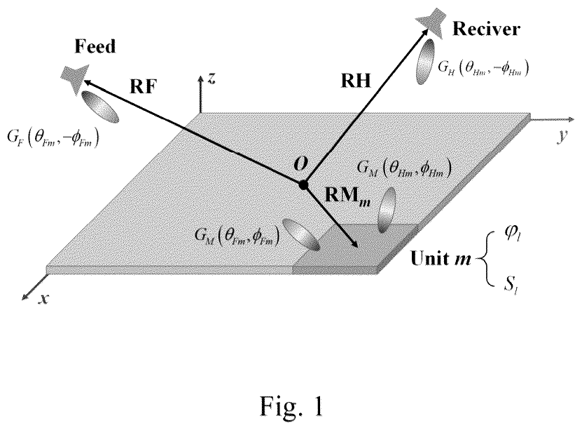

The principle of the invention is that the metasurface unit is regarded as an independent radiating unit. Because the aperture and far-field boundary of the unit are small, the radiation electric field radiated by the metasurface unit to a receiver under different channel characteristics and states is calculated through the Friis transmission equation and the amplitude and phase characteristics of the unit, and a programming expression of wireless energy transfer efficiency and gain is calculated based on the principle of field superposition, so as to achieve the purpose of optimizing metasurface unit arrangement. The principle diagram is shown in FIG. 1.

The principle of the invention is as follows.

Firstly, far-field gain direction diagrams of a feed, a metasurface unit and a receiver are extracted and the relative positions of the feed, the metasurface unit and the receiver are determined. During the implementation of the method of the invention, it is assumed that the metasurface unit radiates uniformly in all directions, so that total channel characteristics of an m^{th} metasurface unit are expressed as:

$${a}_{m} = \sqrt{{G}_{M} ( {θ}_{Fm} , {ϕ}_{F m} ) {G}_{F} ( {θ}_{Fm} , - {ϕ}_{F m} ) {( \frac{λ}{4 π \vert RF - R {M}_{m} \vert} )}^{2}} \qquad ( 1 )$$

$${b}_{m} = \sqrt{{G}_{M} ( {θ}_{Hm} , {ϕ}_{H m} ) {G}_{H} ( {θ}_{Hm} , - {ϕ}_{H m} ) {( \frac{λ}{4 π \vert RH - R {M}_{m} \vert} )}^{2}} \qquad ( 2 )$$

$${F}_{m} = {a}_{m} exp ( - \frac{j 2 π \vert RF - {RM}_{m} \vert}{λ} ) \qquad ( 3 )$$

$${H}_{m} = {b}_{m} exp ( \frac{j 2 π \vert RH - R {M}_{m} \vert}{λ} ) \qquad ( 4 )$$

$${C}_{m} = {H}_{m}^{*} {F}_{m} \qquad ( 5 )$$

where λ denotes working wavelength, aₘ and bₘ denote channel attenuation from the feed to the m^{th} metasurface unit and channel attenuation from the receiver to the m^{th} metasurface unit respectively, Fₘ and Hₘ denote channel characteristics from the m^{th} unit to the feed and the receiver respectively, Cₘ is the total channel characteristics of the m^{th} metasurface unit, m=1, 2, . . . , M and M is the total number of metasurface units. RMₘ, RF and RH are coordinate vectors of the m^{th} unit, the feed and the receiver which are acquired by establishing a rectangular coordinate system with a geometric center of the metasurface as the origin. θ_{Fm} and Φ_{Fm} denote a pitch angle and an azimuth angle of a relative coordinate vector RF-RMₘ between the feed and the m^{th} unit respectively, G_{M}(θ_{Fm},Φ_{Fm}) denotes actual gain of the m^{th} metasurface unit in a state of joint polarization with the feed in the direction of (θ_{Fm},Φ_{Fm}), and G_{F}(θ_{Fm},−Φ_{Fm}) denotes actual gain of the feed in a state of joint polarization with the m^{th} metasurface unit in the direction of (θ_{Fm},−Φ_{Fm}). θ_{Hm} and Φ_{Hm} denote a pitch angle and an azimuth angle of a relative coordinate vector RH-RMₘ between the receiver and the m^{th} unit respectively, G_{M}(θ_{Hm},Φ_{Hm}) denotes actual gain of the m^{th} metasurface unit in a state of joint polarization with the receiver in the direction of (θ_{Hm},Φ_{Hm}), and G_{H}(θ_{Hm},−Φ_{Hm}) denotes actual gain of the receiver in a state of joint polarization with the m^{th} metasurface unit in the direction of (θ_{Hm},−θ_{Hm}).

Grouping is performed according to the total channel characteristics of each metasurface unit, that is, the units with the same total channel characteristics C among the M metasurface units are grouped together. The number dₙ of units contained in each group is acquired, n=1, 2, . . . , N, and N is the number of groups. The total channel characteristic matrix C of the metasurface is acquired, elements in the matrix are the total channel characteristics Cₙ of each group of units, and the matrix size is N×1.

Secondly, the amplitude and phase characteristics of the metasurface unit are extracted, so that the influence of each state of the metasurface unit on the amplitude and phase of electromagnetic waves is expressed as:

$${U}_{l} = \vert {S}_{l} \vert exp ( j {φ}_{l} ) \qquad ( 6 )$$

where Uₗ represents the influence of the metasurface unit on the amplitude and phase of electromagnetic waves in the state l, Sₗ and φₗ represent the amplitude and phase characteristics of the metasurface unit in the state l, l=1, 2, . . . , L, and L is the number of states of the metasurface unit.

The matrix U is acquired, elements in the matrix are the influence Uₗ of each state of the unit on the amplitude and phase of the electromagnetic waves, and the matrix size is 1×L. When L is large, 4-bit sampling is performed on the amplitude and phase characteristics to acquire the matrix U for L=16.

Then, the overall influence T of each state of each metasurface unit on the electromagnetic waves in the system is calculated:

$$T = C U \qquad ( 7 )$$

where the size of the matrix T is N×L.

Next, according to the matrix T and the principle of electric field superposition, each complex element in the matrix is mapped into a plane vector, and a quadratic 0-1 integer programming expression of energy transfer efficiency is obtained:

$$\begin{matrix}max & {{W}_{e} ( x ) = \vert {\sum }_{n = 1}^{N} {\sum }_{l = 1}^{L} {d}_{n} {\vec{a}}_{n l} {x}_{n l} \vert}^{2} \\ s . t . & \begin{matrix}{\sum }_{l = 1}^{L} {x}_{n l} = 1 & n = 1 , 2 , … , N\end{matrix} \\ & {x}_{n l} = 0 , 1\end{matrix} \qquad ( 8 )$$

where \vec{a}ₙₗ is the plane vector mapped from each complex element in the matrix T, and Wₑ(x) is an objective function of the programming expression of the energy transfer efficiency. Here, x denotes decision variable, xₙₗ being 1 means that the units in the n^{th} group are selected as state l, and xₙₗ being 0 means that the units in the n^{th} group are not selected as state l.

The objective function Wₑ(x) of the above expression may be transformed into the following quadratic form:

$${W}_{e} ( x ) = {x}^{T} ( \begin{matrix}{d}_{1}^{2} {\vec{a}}_{1}^{2} & … & {d}_{1} {d}_{i} {\vec{a}}_{1} \cdot {\vec{a}}_{i} \\ ⋮ & ⋱ & ⋮ \\ {d}_{1} {d}_{i} {\vec{a}}_{1} \cdot {\vec{a}}_{i} & … & {d}_{i}^{2} {\vec{a}}_{i}^{2}\end{matrix} ) x \qquad ( 9 )$$

where i=1, 2, . . . , NL;
based on the Friis transmission equation, a quadratic 0-1 integer programming objective function W_{g} of the gain is acquired by placing the receiver outside a far-field boundary of the metasurface and setting the gain of the receiver to 1:

$${W}_{g} ( x ) = {( \frac{4 π R}{λ} )}^{2} {\vert {\sum }_{n = 1}^{N} {\sum }_{l = 1}^{L} {d}_{n} {\vec{a}}_{n l} {x}_{n l} \vert}^{2} \qquad ( 10 )$$

where W_{g} is the objective function of the programming expression of the gain, and R is the distance from a geometric center of the metasurface to a phase center of the receiver.

Finally, the quadratic 0-1 integer programming is linearized into the following form:

$$\begin{matrix}min & V ( x ) = {q}_{0} + {\sum }_{i = 1}^{N L} {q}_{ii} {x}_{i} + {\sum }_{\begin{matrix}i = 1 \\ i \neq k\end{matrix}}^{N L} {\sum }_{k = 1}^{N L} {q}_{i k} {p}_{ik} \\ s . t . & \begin{matrix}0 \leq {x}_{i} + {x}_{k} - 2 {p}_{ik} \leq 1 & i , k = 1 , 2 , … , NL & i < k\end{matrix} \\ & \begin{matrix}{x}_{i} = 0 , 1 & i = 1 , 2 , … , NL\end{matrix} \\ & \begin{matrix}{p}_{ik} = 0 , 1 & i , k = 1 , 2 , … , NL & i < k\end{matrix}\end{matrix} \qquad ( 11 )$$

A solution of the 0-1 integer linear programming problem is acquired through a solver. The solution of the above programming problem is used to obtain optimized energy transfer efficiency or optimized gain, and obtain optimized metasurface unit arrangement. For the above-mentioned 4-bit sampling, considering whether there are better results in other states of the metasurface unit before sampling.

When the method of the invention is implemented, the data to be obtained include:
(1) the relative positions of the feed, the metasurface and the receiver;
(2) the far-field gain direction diagrams of the feed, the metasurface unit and the receiver; and
(3) the amplitude and phase characteristics of the metasurface unit.

In one embodiment, the working frequency of a wireless energy transfer system based on a transmission metasurface is 5.8 Ghz, a standard horn of 5.8 GHz is used as the feed, and the metasurface consists of 10×10 units.

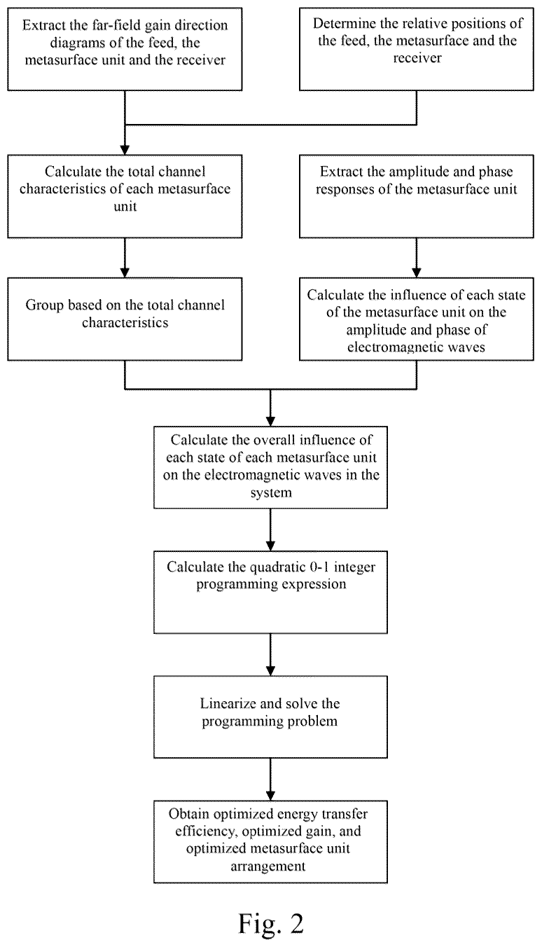

In this embodiment, the calculation flow is shown in FIG. 2. The operations in the flowchart do not need to be performed in sequence. Instead, the operations can be implemented in reverse order or concurrently. In addition, one or more other operations can be added to the flowchart. One or more operations can be removed from the flowchart.
Step 1: extract the far-field gain direction diagrams of the feed, the metasurface unit and the receiver.

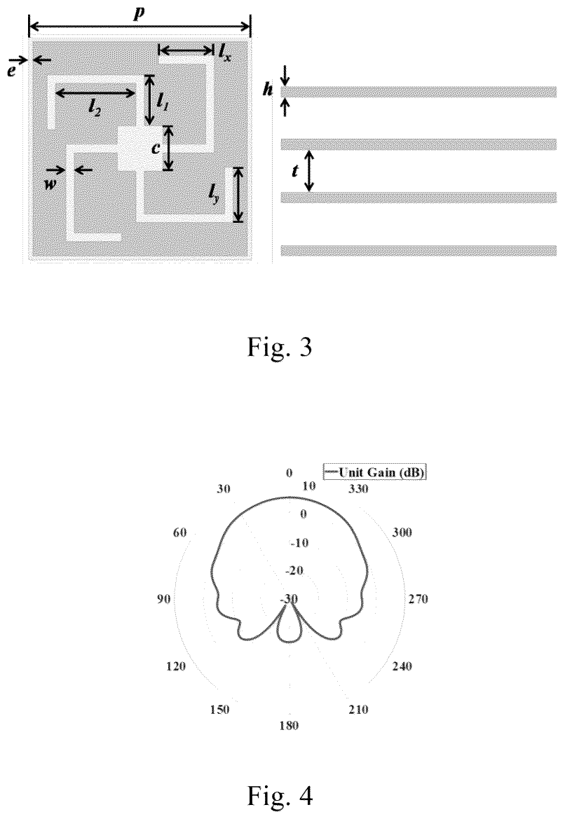

The transmission metasurface unit used in this embodiment is a four-layer windmill structure as shown in FIG. 3. The unit works at 5.8 GHz, the side length of the unit is p=26 mm, the distance between layers is t=4 mm, the thickness of a dielectric substrate in each layer is h=1 mm, the material is F4B, and the dielectric constant is 2.65. Other parameters are as follows: c=5.3 mm, l₁=6 mm, l₂=9.35 mm, w=1 mm, e=0.5 mm, l_{y}=6.5 mm, the range of lₓ is 3-14 mm, and the step size is 0.1 mm.

The far-field gain direction diagram of the metasurface unit in this embodiment is shown in FIG. 4.

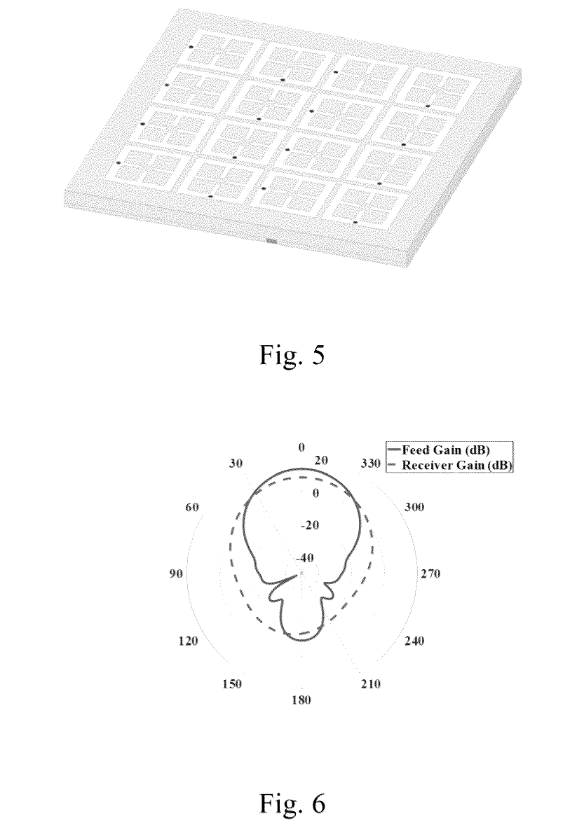

The receiver adopted in this embodiment is an antenna structure shown in FIG. 5.

In this embodiment, the far-field gain direction diagrams of the feed and the receiver are shown in FIG. 6.

The above far-field gain direction diagrams are obtained by simulation software.
Step 2: determine the relative positions of the feed, the metasurface and the receiver.

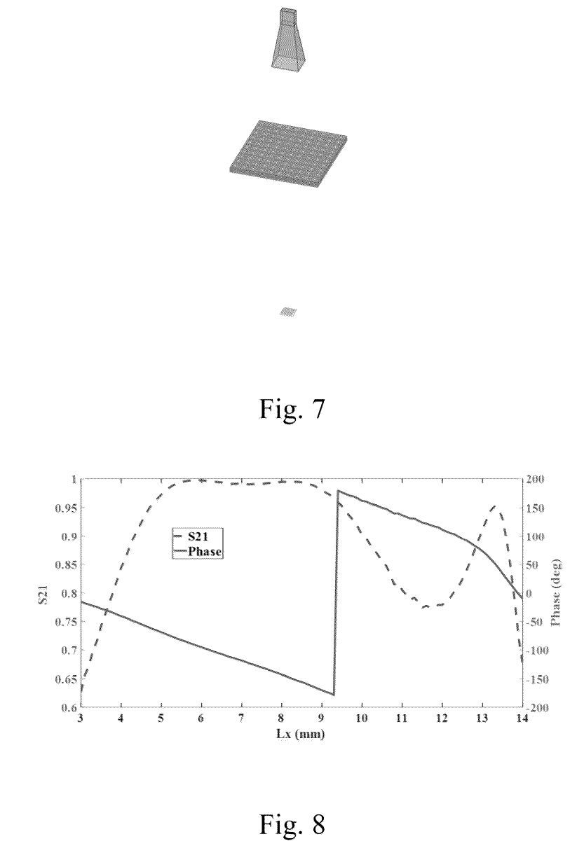

FIG. 7 is a schematic diagram of the wireless energy transfer system based on the transmission metasurface in this embodiment. When a rectangular coordinate system is established with a geometric center of the metasurface as the origin, the feed is located at (0, 0, 0.3) m, and the receiver is located at (0, 0,−R)m, where R is the distance from the geometric center of the metasurface to a phase center of the receiver, the variation range of R is 0.49-0.55 m, and the step length is 0.01 m. According to the unit perimeter p, the relative positions of each metasurface unit relative to the feed and the receiver can be determined.
Step 3: extract the amplitude and phase characteristics of the metasurface unit.

FIG. 8 is a graph showing the variation of the amplitude and phase characteristics of the unit with lₓ.

The amplitude and phase characteristics of the unit are obtained by simulation software.
Step 4: calculate the total channel characteristics of each metasurface unit, and group on this basis to obtain a total channel characteristic matrix.

According to Formula (1) to Formula (5), the total channel characteristics of a total of 100 units are calculated and divided into 14 groups.
Step 5: calculate the influence of each state of the metasurface unit on the amplitude and phase of electromagnetic waves.

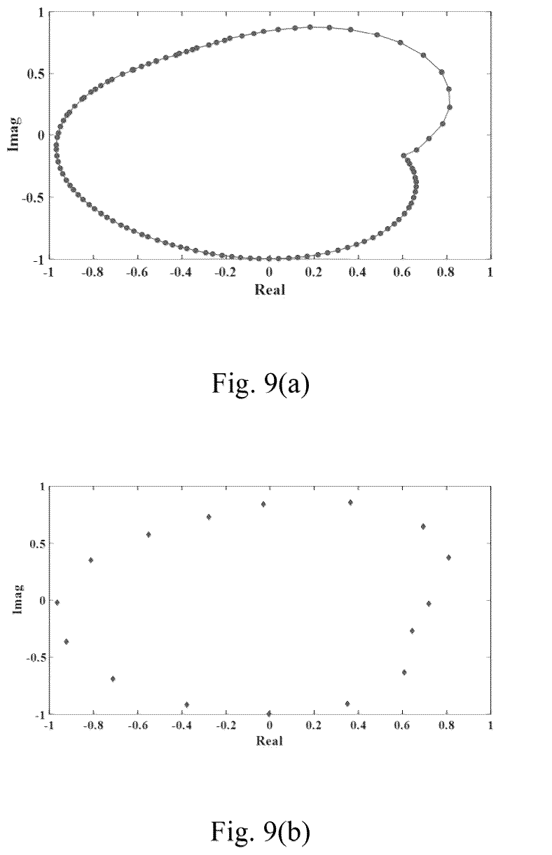

According to Formula (6), the matrix U of the unit is calculated, and its plane mapping is shown in FIG. 9(a).

The metasurface unit has a total of 111 states, and the matrix U after 4-bit sampling is shown in FIG. 9(b).

Step 6: calculate the overall influence of each state of each metasurface unit on the electromagnetic waves in the system, and based on this, calculate the quadratic 0-1 integer programming expression.

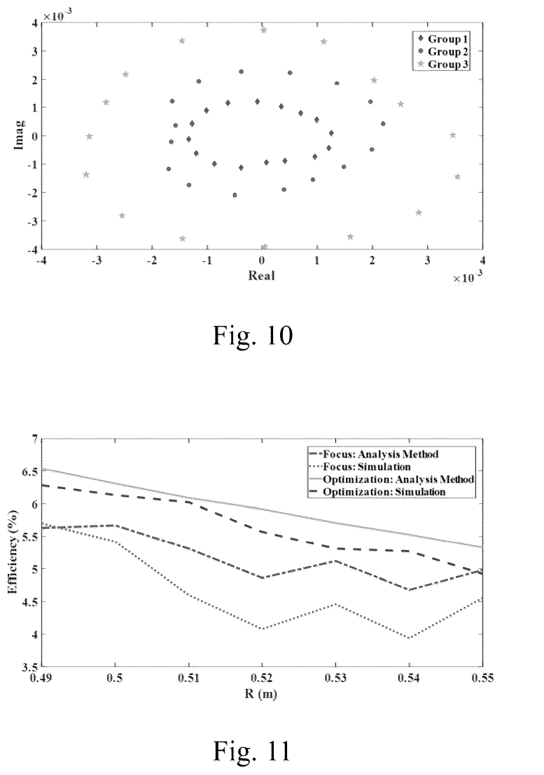

According to Formula (7), the matrix T of the metasurface is calculated, and its partial data plane mapping is shown in FIG. 10. The quadratic 0-1 integer programming expression is calculated according to Formulas (8) and (9).
Step 7: linearize the programming problem and solve it to obtain the optimized energy transfer efficiency and the optimized metasurface unit arrangement.

The programming problem calculated in step 6 is linearized according to Formula (11), and the solution of the linearized programming problem is obtained through the solver.

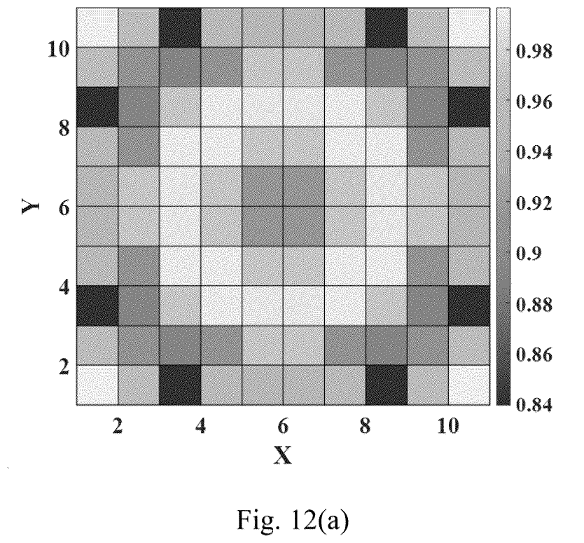

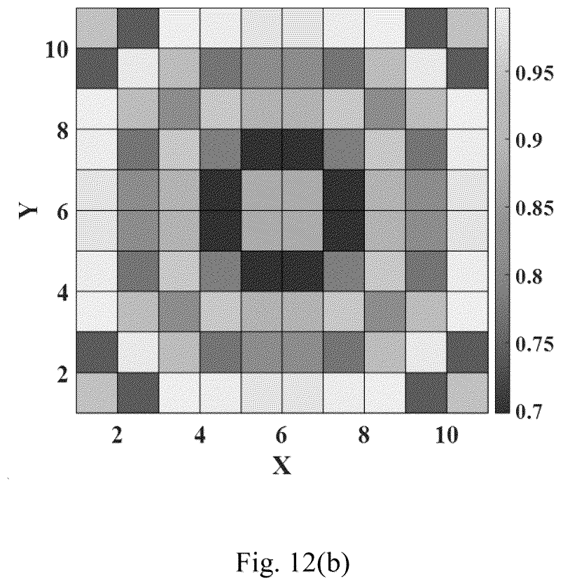

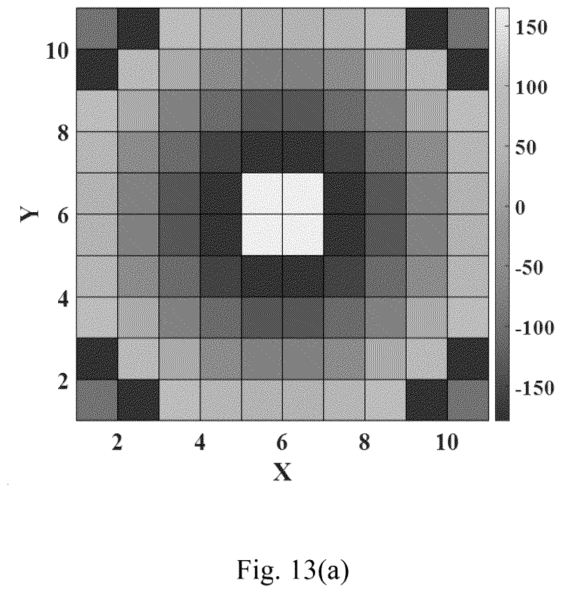

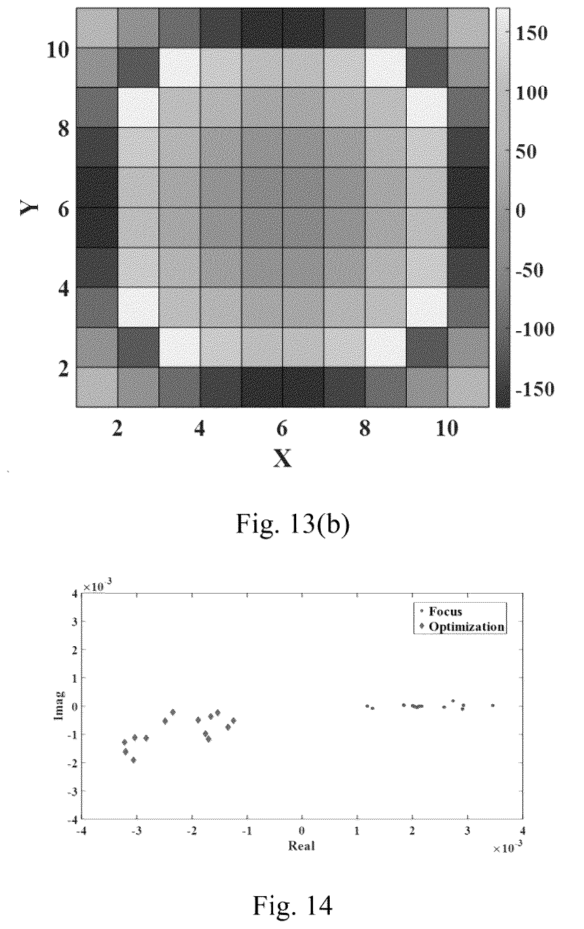

Due to the 4-bit sampling in step 5, according to the solution of the programming problem, whether there are better results in the 111 States before the sampling of the metasurface units is considered, and the optimized energy transfer efficiency and the optimized metasurface unit arrangement are obtained. The evaluation and simulation results of the optimized energy transfer efficiency varying with R are shown in FIG. 11. FIGS. 12(a) and 13(a) are schematic diagrams of the amplitude characteristics and phase characteristics of the optimized metasurface when R=0.52 m, and FIG. 14 is a schematic diagram of plane mapping of energy transfer contribution of each optimized metasurface unit when R=0.52 m.

In the following, a result of a traditional focusing design method is used as a contrast, wireless energy transfer efficiency is obtained by simulation as an accurate result, and the correctness and optimization effect of the transfer efficiency evaluation method provided by the invention are verified by comparison.

The traditional focusing design formula is as follows:

$${φ}_{m} = \frac{2 π}{λ} ( \vert RF - R {M}_{m} \vert + \vert RD - R {M}_{m} \vert ) \qquad ( 12 )$$

where φₘ is the compensation phase of the m^{th} metasurface unit, and RD is the coordinate vector of the focus. In this embodiment, the phase centers of the focus and the receiver are located at the same position.

According to Formula (12), the amplitude Sₘ and phase characteristics φₘ of the m^{th} unit are determined, and the following formula is used to evaluate the energy transfer efficiency η of the focused metasurface:

$$η = {\vert {\sum }_{m = 1}^{M} {C}_{m} {U}_{m} \vert}^{2} \qquad ( 13 )$$

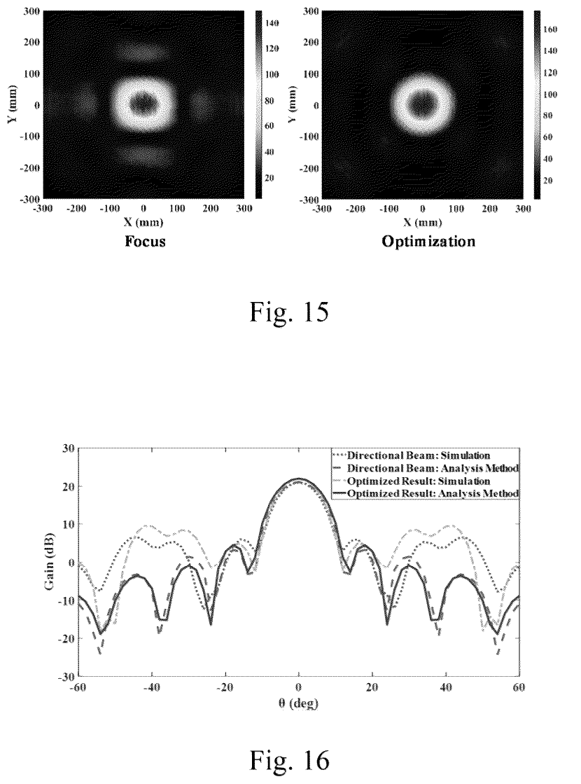

The evaluation and simulation results of the energy transfer efficiency of the focused metasurface varying with R are shown in FIG. 11. FIGS. 12(b) and 13(b) are schematic diagrams of the distribution of amplitude characteristics and phase characteristics of the focused metasurface when R=0.52 m, and FIG. 14 is a schematic diagram of the plane mapping of the energy transfer contribution of each focused metasurface unit when R=0.52 m. When R=0.52 m, the evaluation result of the energy transfer efficiency based on the focused metasurface is 4.86%, and the simulation result is 4.08%. The evaluation result of the energy transfer efficiency optimized by the method of the invention is 5.92%, and the simulation result is 5.57%. It can be seen that the optimized result is improved by 36.52%. As can be seen from FIG. 11, the evaluation result of the invention is very close to the simulation result, which can reflect the variation of energy transfer efficiency of the focused and optimized metasurface with R. It can be seen that the traditional focusing method will lead to the fluctuation of the overall value of the amplitude characteristics of the metasurface, so the energy transfer efficiency does not always decrease with the increase of the distance R, while the optimized results have relatively high stability and are generally higher than the focusing design results. It can be seen by comparing FIGS. 11-14 that the method of the invention can not only improve the overall value of the amplitude characteristics of the metasurface, but also relatively maintain the phase consistency among the energy transfer contributions of each unit, thus obtaining better electromagnetic wave superposition effect and energy transfer efficiency. The electric field intensity distribution of the receiving cross section in FIG. 15 shows that the optimization can improve the overall electromagnetic power level of a target position.

In another embodiment, the same metasurface is used to complete the gain design with the principal direction perpendicular to the metasurface.

A traditional directional beam design formula is as follows:

$${φ}_{m} = \frac{2 π}{λ} ( \vert RF - R {M}_{m} \vert - ( {x}_{m} cos {φ}_{b} + {y}_{m} sin {φ}_{b} ) sin {θ}_{b} ) \qquad ( 14 )$$

where xₘ and yₘ are the x and y coordinates of the m^{th} metasurface unit respectively, and the pitch angle and azimuth angle of the principal beam direction are θ_{b} and φ_{b}, respectively. In this embodiment, the principal beam direction is perpendicular to the metasurface.

According to Formula (14), the amplitude Sₘ and phase characteristics φₘ of the m^{th} unit are determined, and the following formula is used to evaluate the gain G_{D} of the directional beam metasurface:

$${G}_{D} = {( \frac{4 π R}{λ} )}^{2} {\vert {\sum }_{m = 1}^{M} {C}_{m} {U}_{m} \vert}^{2} \qquad ( 15 )$$

In this embodiment, Formula (10) is used to replace the objective function in Formula (8), and the directional beam design result is compared with the optimized result. Other implementation steps and required parameters are the same as those in the previous embodiment.

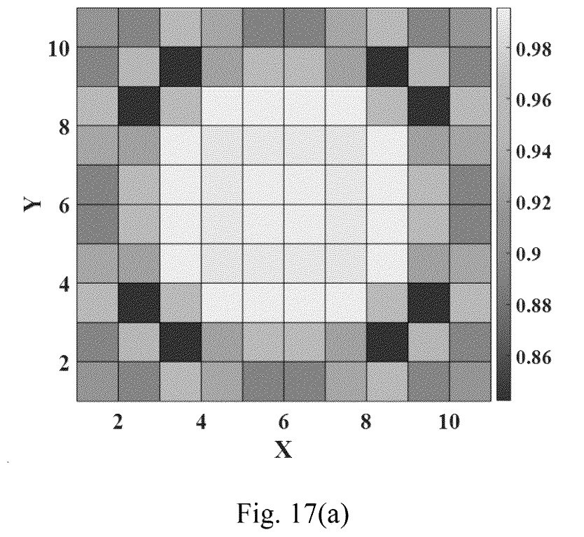

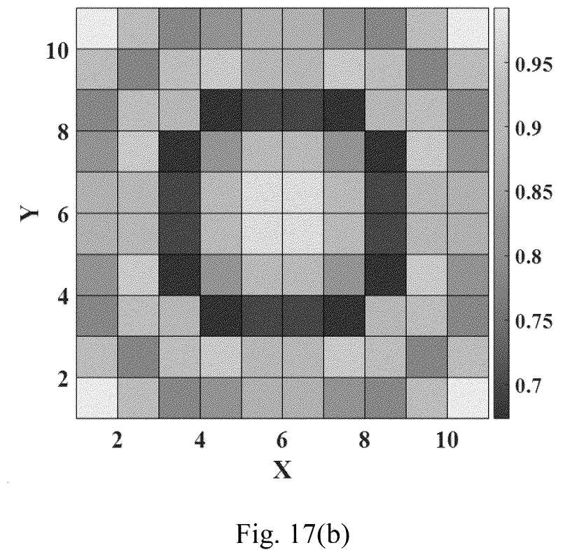

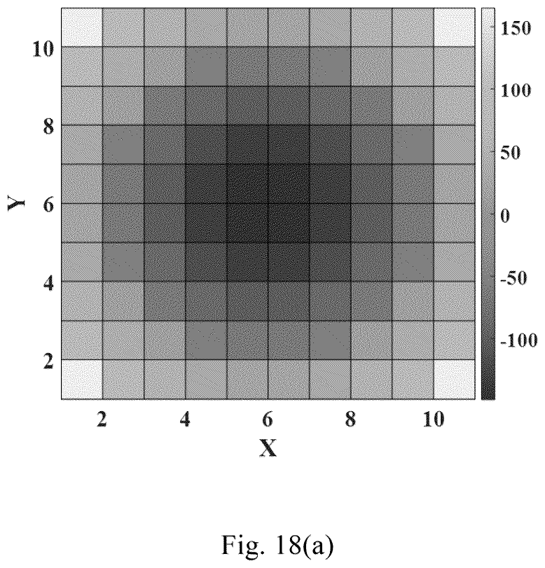

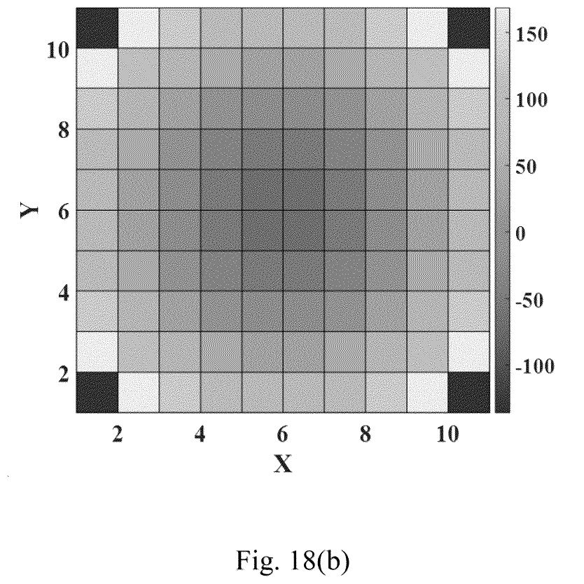

FIG. 16 is a far-field gain direction diagram of a directional beam and optimized metasurface. FIGS. 17(a) and 18(a) are amplitude and phase characteristic distribution diagrams of an optimized metasurface, and FIGS. 17(b) and 18(b) are amplitude and phase characteristic distribution diagrams of a directional beam metasurface.

It can be seen that the evaluation result of the gain in the principal direction of the invention is very close to the simulation result. The gain evaluation result based on the directional beam metasurface is 21.09 dB, and the simulation result is 20.99 dB. The gain evaluation result optimized by the method of the invention is 22.02 dB, and the simulation result is 21.97 dB. It can be seen that the optimized result is improved by 25.32%.

To sum up, the principle of the invention is that the metasurface unit is regarded as an independent radiating unit. Because the aperture and far-field boundary of the unit are small, the radiation electric field radiated by the metasurface unit to a receiver under different channel characteristics and states is calculated through the Friis transmission equation and the amplitude and phase characteristics of the unit, and a programming expression of wireless energy transfer efficiency and gain is calculated based on the principle of field superposition, so as to achieve the purpose of optimizing metasurface unit arrangement. The existing metasurface focusing and directional beam design formulas consider the phase difference of electromagnetic waves propagating in different paths in space, and better radiation electric field superposition effects can be obtained by adjusting the compensation phase of the unit, but they ignore the amplitude change of electromagnetic waves caused by spatial attenuation and unit characteristics. For some reflective metasurface units, S₁₁ is very close to 1 for all unit structures, and the optimization space for focusing and directional beam design results is small. However, the amplitude characteristics of transmission metasurface units and reconfigurable units do not always keep a high value, so there is a very large optimization space using the method of the invention. By using numerical calculation and programming-based methods, compared to the pure simulation method, the invention has the advantages of high efficiency, fast operation, easy use, and small computational resource utilization.

Through the description of the above implementation modes, those skilled in the art can clearly understand that the calculation method of the present disclosure can be realized by means of software and necessary general hardware, and of course it can also be realized by special hardware including special integrated circuits, special CPU, special memory, special components and so on. In general, all functions completed by computer programs can be easily realized by corresponding hardware, and the specific hardware structures used to realize the same function can also be varied, such as analog circuits, digital circuits or special circuits. However, for the present disclosure, in many cases, software program implementation is a better option.

What is claimed is:

1. An analysis method for evaluating and optimizing wireless energy transfer efficiency and gain of electromagnetic metasurfaces, comprising the following steps:
acquiring total channel characteristics Cₘ of an m^{th} metasurface unit in a system, m=1, 2, . . . , M, M being the total number of metasurface units;
acquiring a total channel characteristic matrix C of the metasurface in the system;
acquiring a matrix U, elements in U representing the influence of each state of the metasurface units on the amplitude and phase of electromagnetic waves;
acquiring a matrix T, elements in T representing the overall influence of each state of the metasurface units on the electromagnetic waves in the system;
acquiring a quadratic 0-1 integer programming problem for determining the energy transfer efficiency or gain; and
using a solution of the above programming problem to obtain optimized energy transfer efficiency or optimized gain, and obtain optimized metasurface unit arrangement.

2. The analysis method for evaluating and optimizing wireless energy transfer efficiency and gain of electromagnetic metasurfaces according to claim 1, wherein the total channel characteristics Cₘ of an m^{th} metasurface unit in a system are acquired by the following steps:
establishing a rectangular coordinate system with a geometric center of the metasurface as the origin, and acquiring coordinate vectors RMₘ, RF and RH of the m^{th} unit, a feed and a receiver;
based on a pitch angle θ_{Fm} and an azimuth angle Φ_{Fm} of a relative coordinate vector RF-RMₘ between the feed and the m^{th} unit, acquiring actual gain G_{M}(θ_{Fm},Φ_{Fm}) of the m^{th} metasurface unit in a state of joint polarization with the feed in the direction of (θ_{Fm},Φ_{Fm}) and actual gain G_{F}(θ_{Fm},−Φ_{Fm}) of the feed in a state of joint polarization with the m^{th} metasurface unit in the direction of (θ_{Fm},−Φ_{Fm}), the gain being acquired by simulation;
based on a pitch angle θ_{Hm} and an azimuth angle Φ_{Hm} of a relative coordinate vector RH-RMₘ between the receiver and the m^{th} unit, acquiring actual gain G_{M}(θ_{Hm},Φ_{Hm}) of the m^{th} metasurface unit in a state of joint polarization with the receiver in the direction of (θ_{Hm},Φ_{Hm}) and actual gain G_{H}(θ_{Hm},−Φ_{Hm}) of the receiver in a state of joint polarization with the m^{th} metasurface unit in the direction of (θ_{Hm},−Φ_{Hm}), the gain being acquired by simulation;
based on the coordinate vectors and the gain, calculating channel attenuation aₘ from the feed to the m^{th} metasurface unit and channel attenuation bₘ from the receiver to the m^{th} metasurface unit according to the following formula:
$$\begin{matrix}{a}_{m} = \sqrt{{G}_{M} ( {θ}_{Fm} , {ϕ}_{F m} ) {G}_{F} ( {θ}_{Fm} , - {ϕ}_{F m} ) {( \frac{λ}{4 π \vert RF - R {M}_{m} \vert} )}^{2}} \\ {b}_{m} = \sqrt{{G}_{M} ( {θ}_{Hm} , {ϕ}_{H m} ) {G}_{H} ( {θ}_{Hm} , - {ϕ}_{H m} ) {( \frac{λ}{4 π \vert RH - R {M}_{m} \vert} )}^{2}}\end{matrix}$$
where λ denotes working wavelength;
calculating channel characteristics Fₘ from the m^{th} metasurface unit to the feed and the receiver and channel characteristics Hₘ to the receiver according to the following formula:
$$\begin{matrix}{F}_{m} = {a}_{m} exp ( - \frac{j 2 π \vert RF - R {M}_{m} \vert}{λ} ) \\ {H}_{m} = {b}_{m} exp ( \frac{j 2 π \vert RH - R {M}_{m} \vert}{λ} )\end{matrix}$$
calculating the total channel characteristic Cₘ of the m^{th} metasurface unit according to the following formula:
$${C}_{m} = {H}_{m}^{*} {F}_{m} ,$$

3. The analysis method for evaluating and optimizing wireless energy transfer efficiency and gain of electromagnetic metasurfaces according to claim 1, wherein the total channel characteristic matrix C is acquired by the following steps:
grouping according to the total channel characteristics of each metasurface unit, that is, grouping together the units with the same total channel characteristics Cₘ among the M metasurface units;
acquiring the number dₙ of units contained in each group, n=1, 2, . . . , N, N being the number of groups; and
acquiring the total channel characteristic matrix C of the metasurface, elements in the matrix being the total channel characteristics Cₙ of each group of units, and the matrix size being N×1.

4. The analysis method for evaluating and optimizing wireless energy transfer efficiency and gain of electromagnetic metasurfaces according to claim 1, wherein the matrix U is acquired by the following steps:
acquiring amplitude characteristics Sₗ and phase characteristics φₗ of the metasurface unit in the state l through simulation, l=1, 2, . . . , L, L being the number of states of the metasurface unit;
based on the amplitude characteristics and the phase characteristics, calculating the influence Uₗ of the metasurface unit on the amplitude and phase of the electromagnetic waves in the state l according to the following formula:
$${U}_{l} = \vert {S}_{l} \vert exp ( j {φ}_{l} )$$
acquiring the matrix U, elements in the matrix being the influence Uₗ of each state of the unit on the amplitude and phase of the electromagnetic waves, and the matrix size being 1×L;
when L is large, 4-bit sampling being performed on the amplitude and phase characteristics to acquire the matrix U for L=16.

5. The analysis method for evaluating and optimizing wireless energy transfer efficiency and gain of electromagnetic metasurfaces according to claim 1, wherein the matrix T is acquired by the following steps:
based on the total channel characteristic matrix C and the matrix U, calculating the matrix T representing the overall influence of each state of each metasurface unit on the electromagnetic waves in the system according to the following formula:
$$T = C U$$
where the size of the matrix T is N×L.

6. The analysis method for evaluating and optimizing wireless energy transfer efficiency and gain of electromagnetic metasurfaces according to claim 1, wherein the quadratic 0-1 integer programming expression is acquired by the following steps:
based on the matrix T, mapping each complex element in the matrix into a plane vector \vec{a}ₙₗ;
based on the plane vector \vec{a}ₙₗ, acquiring the quadratic 0-1 integer programming expression of the energy transfer efficiency according to the following formula:
$$\begin{matrix}max & {{W}_{e} ( x ) = \vert {\sum }_{n = 1}^{N} {\sum }_{l = 1}^{L} {d}_{n} {\vec{a}}_{n l} {x}_{n l} \vert}^{2} \\ s . t . & \begin{matrix}{\sum }_{l = 1}^{L} {x}_{n l} = 1 & n = 1 , 2 , … , N\end{matrix} \\ & {x}_{n l} = 0 , 1\end{matrix}$$
where x denotes decision variable, xₙₗ being 1 means that the units in the n^{th} group are selected as state l, and xₙₗ being 0 means that the units in the n^{th} group are not selected as state l;
an objective function Wₑ(x) of the above expression being transformed into the following quadratic form:
$${W}_{e} ( x ) = {x}^{T} ( \begin{matrix}{d}_{1}^{2} {\vec{a}}_{1}^{2} & … & {d}_{1} {d}_{i} {\vec{a}}_{1} \cdot {\vec{a}}_{i} \\ ⋮ & ⋱ & ⋮ \\ {d}_{1} {d}_{i} {\vec{a}}_{1} \cdot {\vec{a}}_{i} & … & {d}_{i}^{2} {\vec{a}}_{i}^{2}\end{matrix} ) x$$
where i=1, 2, . . . , NL.

7. The analysis method for evaluating and optimizing wireless energy transfer efficiency and gain of electromagnetic metasurfaces according to claim 1, wherein based on the Friis transmission equation, a quadratic 0-1 integer programming objective function W_{g} of the gain is acquired according to the steps and the following formula by placing the receiver outside a far-field boundary of the metasurface and setting the gain of the receiver to 1:
$${W}_{g} ( x ) = {( \frac{4 π R}{λ} )}^{2} {\vert {\sum }_{n = 1}^{N} {\sum }_{l = 1}^{L} {d}_{n} {\vec{a}}_{n l} {x}_{n l} \vert}^{2}$$
where R is the distance from a geometric center of the metasurface to a phase center of the receiver.

8. The analysis method for evaluating and optimizing wireless energy transfer efficiency and gain of electromagnetic metasurfaces according to claim 7, wherein the quadratic 0-1 integer programming is linearized into the following form:
$$\begin{matrix}min & V ( x ) = {q}_{0} + {\sum }_{i = 1}^{N L} {q}_{ii} {x}_{i} + {\sum }_{\begin{matrix}i = 1 \\ i \neq k\end{matrix}}^{N L} {\sum }_{k = 1}^{N L} {q}_{i k} {p}_{ik} \\ s . t . & \begin{matrix}0 \leq {x}_{i} + {x}_{k} - 2 {p}_{ik} \leq 1 & i , k = 1 , 2 , … , NL & i < k\end{matrix} \\ & \begin{matrix}{x}_{i} = 0 , 1 & i = 1 , 2 , … , NL\end{matrix} \\ & \begin{matrix}{p}_{ik} = 0 , 1 & i , k = 1 , 2 , … , NL & i < k\end{matrix}\end{matrix}$$
acquiring a solution of the 0-1 integer linear programming problem through a solver; and
using the solution of the above programming problem to obtain optimized energy transfer efficiency or optimized gain, and obtain optimized metasurface unit arrangement.

9. A calculating device based on the analysis method for evaluating and optimizing wireless energy transfer efficiency and gain of electromagnetic metasurfaces according to claim 1, comprising a calculating module, wherein
the calculating module is configured to perform the following operations:
acquiring total channel characteristics Cₘ of an m^{th} metasurface unit in a system, m=1, 2, . . . , M, M being the total number of metasurface units;
acquiring a total channel characteristic matrix C of the metasurface;
acquiring a matrix U, elements in U representing the influence of each state of the metasurface units on the amplitude and phase of electromagnetic waves;
acquiring a matrix T, elements in T representing the overall influence of each state of the metasurface units on the electromagnetic waves in the system;
acquiring a quadratic 0-1 integer programming problem for determining the energy transfer efficiency or gain; and
using a solution of the above programming problem to obtain optimized energy transfer efficiency or optimized gain, and obtain optimized metasurface unit arrangement.
